(19) United States
(12) Patent Application Publication
(10) Pub. No.: US 2025/0178318 A1
(43) Pub. Date: Jun. 5, 2025

(54) DISPLAY DEVICE

(71) Applicant: E Ink Holdings Inc., Hsinchu (TW)

(72) Inventors: Deng-Kuen Shiau, Hsinchu (TW); Chih-Chia Chen, Hsinchu (TW); Yue-Feng Lin, Hsinchu (TW); Ming Hui Chiang, Hsinchu (TW)

(73) Assignee: E Ink Holdings Inc., Hsinchu (TW)

(21) Appl. No.: 18/939,551

(22) Filed: Nov. 7, 2024

(30) Foreign Application Priority Data
Nov. 30, 2023 (TW) 112146450

(51) Int. Cl. B32B 17/10; G02B 26/00; G02F 1/167; G02F 1/16755; G02F 1/1679

(52) U.S. Cl. CPC B32B 17/10302; B32B 17/10036; B32B 17/10522; G02F 1/167; G02F 1/16755; G02F 1/1679; B32B 2307/7246; B32B 2307/7376; B32B 2457/20; G02B 26/005

(57) ABSTRACT

A display device includes a laminated glass, a driving substrate, at least one display film, and a sealant layer. The driving substrate is sealed within the laminated glass. The at least one display film is sealed within the laminated glass and is located on the driving substrate. The sealant layer seals edges of the laminated glass.

### CROSS-REFERENCE TO RELATED APPLICATION

This application claims the priority benefit of Taiwan application serial no. 112146450, filed on Nov. 30, 2023. The entirety of the above-mentioned patent application is hereby incorporated by reference herein and made a part of this specification.

### BACKGROUND

### Technical Field

The disclosure relates to a display device, and in particular, to a display device suitable for outdoor use.

### Description of Related Art

In the related art, display devices for outdoor use usually need to be attached with an optically clear adhesive (OCA), an optically clear resin (OCR), a UV barrier film, a moisture barrier film, or a cover glass to increase weather resistance of the display devices. However, the above methods can neither effectively reduce costs nor improve production efficiency. Also, the above methods cannot provide a better water vapor blocking ability but reduce structural reliability of the display devices.

### SUMMARY

The disclosure provides a display device which is suitable for outdoor use and has better structural reliability.

The display device of an embodiment of the disclosure includes a laminated glass, a driving substrate, at least one display film, and a sealant layer. The driving substrate is sealed within the laminated glass. The at least one display film is sealed within the laminated glass and is located on the driving substrate. The sealant layer seals edges of laminated glass.

In an embodiment of the disclosure, the laminated glass includes a first glass substrate, a second glass substrate, and a glass laminating material. The driving substrate is located on the first glass substrate. The second glass substrate is located above the at least one display film. The glass laminating material laminates the first glass substrate and the second glass substrate and covers the driving substrate and the at least one display film.

In an embodiment of the disclosure, a thickness of the first glass substrate and a thickness of the second glass substrate are respectively at least greater than 5 mm.

In an embodiment of the disclosure, a thickness of the glass laminating material is between 0.8 mm and 1.2 mm.

In an embodiment of the disclosure, the glass laminating material includes a safety excellent finesse (SEF) film.

In an embodiment of the disclosure, there is a gap between the at least one display film and the second glass substrate.

In an embodiment of the disclosure, a water vapor transmission rate (WVTR) of the sealant layer is less than 14.5 g/m² day.

In an embodiment of the disclosure, a material of the sealant layer includes epoxy, polymethylmethacrylate (PMMA), silicone or polystyrene (PS).

In an embodiment of the disclosure, an upper surface and a lower surface opposite to each other of the sealant layer are respectively flush with a first surface and a second surface opposite to each other of the laminated glass.

In an embodiment of the disclosure, the at least one display film includes at least one electrophoretic display film or at least one electrowetting display film.

Based on the above, in the design of the display device of the disclosure, the driving substrate and the at least one display film thereon are sealed within the laminated glass, and the sealant layer seals the edges of the laminated glass. With the hardness, the water vapor blocking ability, and the ultraviolet light blocking ability of the laminated glass itself, the weather resistance of the display film for outdoor use may be greatly improved. In short, the display device of the disclosure is suitable for outdoor use and has better structural reliability.

In order to make the above-mentioned features and advantages of the disclosure more obvious and easy to understand, embodiments are given below and described in detail with reference to the accompanying drawings.

### BRIEF DESCRIPTION OF THE DRAWINGS

FIG. 1 is a schematic partial perspective view of a display device according to an embodiment of the disclosure.

FIG. 2 is a schematic cross-sectional view of the display device in FIG. 1.

FIG. 3 is a schematic cross-sectional view of a display device according to an embodiment of the disclosure.

### DESCRIPTION OF THE EMBODIMENTS

The embodiments of the disclosure may be understood together with the drawings, and the drawings of the disclosure are also regarded as portion of the description of the disclosure. It should be understood that the drawings of the disclosure are not drawn to scale and, in fact, the dimensions of components may be enlarged or reduced in any manner in order to clearly represent the features of the disclosure.

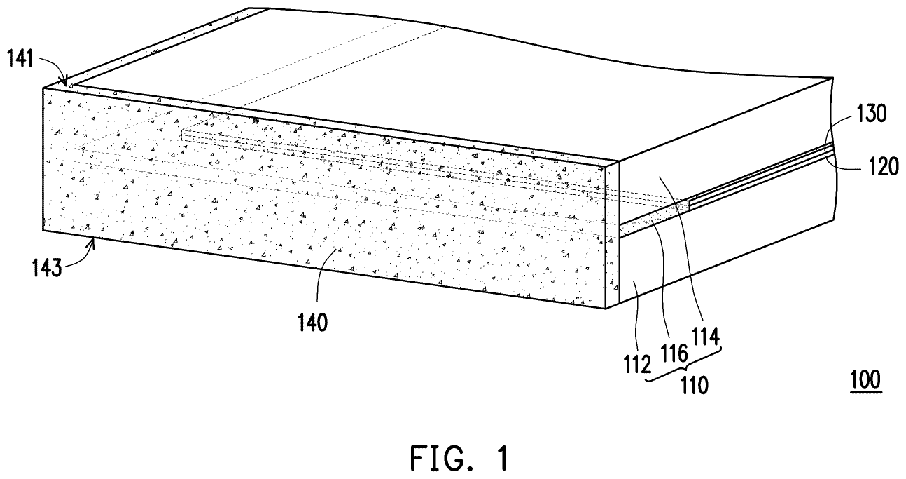

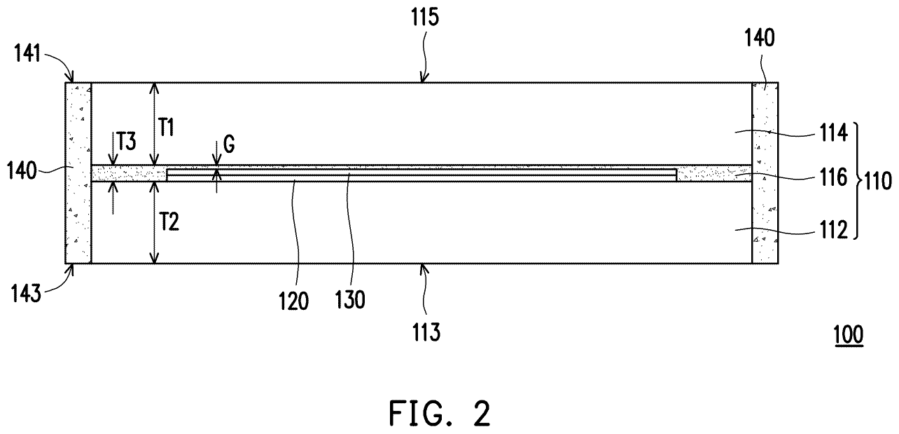

FIG. 1 is a schematic partial perspective view of a display device according to an embodiment of the disclosure. FIG. 2 is a schematic cross-sectional view of the display device in FIG. 1. Referring to FIG. 1 and FIG. 2 at the same time, in this embodiment, a display device 100 includes a laminated glass 110, a driving substrate 120, at least one display film (one display film 130 is schematically illustrated), and a sealant layer 140. The driving substrate 120 is sealed within the laminated glass 110. The display film 130 is sealed within the laminated glass 110 and is located on the driving substrate 120. The sealant layer 140 seals edges of the laminated glass 110.

In detail, the laminated glass 110 of this embodiment includes a first glass substrate 112, a second glass substrate 114, and a glass laminating material 116. The driving substrate 120 is located on the first glass substrate 112. The second glass substrate 114 is located above the display film 130. The glass laminating material 116 laminates the first glass substrate 112 and the second glass substrate 114, and covers the driving substrate 120 and the display film 130.

In this embodiment, the laminated glass 110 is a laminated glass formed by, for example, sandwiching the glass laminating material 116 between two pieces of glass (that is, the first glass substrate 112 and the second glass substrate 114) and laminating the two pieces of glass together at a temperature ranging from 75° C. to 80° C. In an embodiment, the laminated glass may also be composed of more than two pieces of glass with the glass laminating material sandwiched between any two pieces of glass. Generally, the laminated glass may also be called shatterproof safety glass because the laminating material between the two pieces of glass is fixed to the glass after heating, and when the glass is broken, the pieces of broken glass still stick together without scattering and injuring people, so the laminated glass is an extremely safe building material.

Moreover, referring to FIG. 2 again, in this embodiment, a thickness T2 of the first glass substrate 112 is, for example, at least greater than 5 mm, and a thickness T1 of the second glass substrate 114 is, for example, at least greater than 5 mm. In an embodiment, dimensions of the first glass substrate 112 may be exactly the same as dimensions of the second glass substrate 114, where the dimensions include the length, the width, and the height. However, the disclosure is not limited thereto. The light transmittances of the first glass substrate 112 and the second glass substrate 114 are respectively higher than 80%. The first glass substrate 112 and the second glass substrate 114 may have a better water vapor blocking ability than the water blocking film adopted in the related art, and the first glass substrate 112 and the second glass substrate 114 have high hardness and excellent weather resistance and are suitable for outdoor use. Furthermore, the glass laminating material 116 in this embodiment is, for example, a safety excellent finesse (SEF) film, where the glass laminating material 116 may effectively block ultraviolet light. That is, the glass laminating material 116 has an ultraviolet light blocking ability. In an embodiment, a thickness T3 of the glass laminating material 116 is, for example, between 0.8 mm and 1.2 mm but is not limited thereto, as long as the glass laminating material 116 may cover the driving substrate 120 and the display film 130 therein. In short, the laminated glass 110 of this embodiment has the advantages of high safety, an excellent water vapor blocking ability, and effective ultraviolet light isolation, thereby greatly improving the weather resistance of the display film 130 sealed therein for outdoor use.

Referring to FIG. 1 and FIG. 2 at the same time, the driving substrate 120 of this embodiment is, for example, an active component array substrate, such as a thin film transistor (TFT) array substrate or a thin film diode (TFD) array substrate, but the disclosure is not limited thereto. The display film 130 is, for example, an electrophoretic display film or an electrowetting display film, but the disclosure is not limited thereto. The display device 100 is, for example, a reflective display device, such as an electrophoretic display device, but the disclosure is not limited thereto. The driving substrate 120 is configured to drive the display film 130 for display. There is a gap G between the display film 130 and the second glass substrate 114, which means that the display film 130 is not in direct contact with the second glass substrate 114.

In addition, the sealant layer 140 of this embodiment seals surrounding surfaces of the first glass substrate 112, surrounding surfaces of the second glass substrate 114, and surrounding surfaces of the glass laminating material 116, which means that the sealant layer 140 seals the edges of the laminated glass 110 and may effectively block lateral water vapor from entering the laminated glass 110. Further, an upper surface 141 and a lower surface 143 opposite to each other of the sealant layer 140 may be respectively flush with a top surface 115 and a bottom surface 113 opposite to each other of the laminated glass 110, but the disclosure is not limited thereto. Here, the second glass substrate 114 has a top surface 115, and the first glass substrate 112 has a bottom surface 113. In an embodiment, a material of the sealant layer 140 is, for example, epoxy, polymethylmethacrylate (PMMA), silicone or polystyrene (PS). The water vapor transmission rate (WVTR) of the sealant layer 140 is less than 14.5 g/m² day. In an embodiment, the water vapor blocking effect of the sealant layer 140 is better than the water vapor blocking effect of the glass laminating material 116.

In short, in this embodiment, the display film 130 is sealed within the laminated glass 110, and the edges of the laminated glass 110 are sealed by the sealant layer 140 to achieve a waterproof effect. With the hardness, the water vapor blocking ability, and the ultraviolet light blocking ability of the laminated glass 110 itself, the weather resistance of the display film 130 for outdoor use may be greatly improved. Moreover, compared with the related art, the display device 100 of this embodiment may save the cost of the water blocking film and lamination costs of other film layers, and the water blocking ability of the laminated glass 110 of this embodiment is also much higher than the water blocking film of the related art. In addition, the display device 100 of this embodiment may also be applied to tiling or curved surfaces of displays and may have a wider range of applications.

It should be noted that reference numbers of the components and a part of contents of the aforementioned embodiment are also used in the following embodiment, where the same reference numbers denote the same or like components, and descriptions of the same technical contents are omitted. The aforementioned embodiment may be referred for descriptions of the omitted parts, and detailed descriptions thereof are not repeated in the following embodiment.

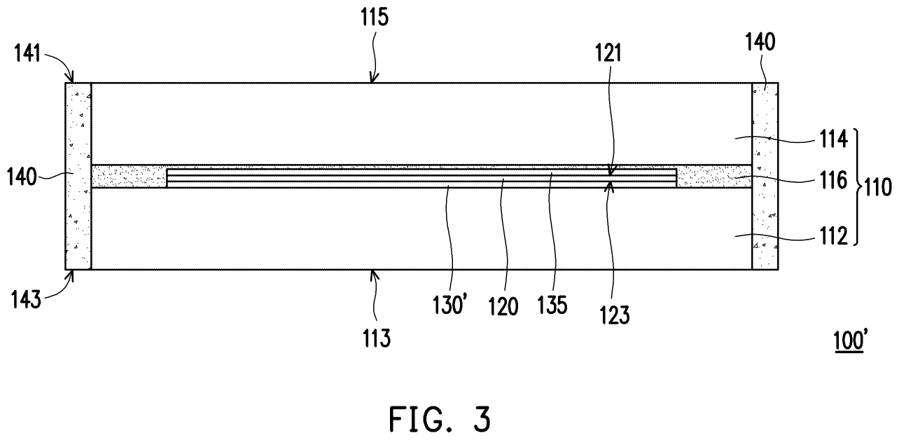

FIG. 3 is a schematic cross-sectional view of a display device according to an embodiment of the disclosure. Referring to FIG. 2 and FIG. 3 at the same time, a display device 100′ of this embodiment is similar to the display device 100 described above, and the difference between the two lies in that: in this embodiment, the display device 100′ includes two display films 130′ and 135, where the display films 130′ and 135 are disposed on an upper surface 121 and a lower surface 123 of the driving substrate 120 respectively. Since the upper surface 121 and the lower surface 123 of the driving substrate 120 both have driving circuits, the display films 130′ and 135 thereon may be driven for display. In other words, the display device 100′ of this embodiment may display on both sides.

To sum up, in the design of the display device of the disclosure, the driving substrate and the display film thereon are sealed within the laminated glass, and the sealant layer seals the edges of the laminated glass. With the hardness, the water vapor blocking ability, and the ultraviolet light blocking ability of the laminated glass itself, the weather resistance of the display film for outdoor use may be greatly improved. In short, the display device of the disclosure is suitable for outdoor use and has better structural reliability.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A display device, comprising:
a laminated glass;
a driving substrate, sealed within the laminated glass;
at least one display film, sealed within the laminated glass and located on the driving substrate; and
a sealant layer, sealing edges of the laminated glass.

2. The display device according to claim 1, wherein the laminated glass comprises:
a first glass substrate, wherein the driving substrate is located on the first glass substrate;
a second glass substrate, located above the at least one display film; and
a glass laminating material, laminating the first glass substrate and the second glass substrate and covering the driving substrate and the at least one display film.

3. The display device according to claim 2, wherein a thickness of the first glass substrate and a thickness of the second glass substrate are respectively at least greater than 5 mm.

4. The display device according to claim 2, wherein a thickness of the glass laminating material is between 0.8 mm and 1.2 mm.

5. The display device according to claim 2, wherein the glass laminating material comprises a safety excellent finesse film.

6. The display device according to claim 2, wherein there is a gap between the at least one display film and the second glass substrate.

7. The display device according to claim 1, wherein a water vapor transmission rate of the sealant layer is less than 14.5 g/m² day.

8. The display device according to claim 1, wherein a material of the sealant layer comprises epoxy, polymethylmethacrylate, silicone or polystyrene.

9. The display device according to claim 1, wherein an upper surface and a lower surface opposite to each other of the sealant layer are respectively flush with a first surface and a second surface opposite to each other of the laminated glass.

10. The display device according to claim 1, wherein the at least one display film comprises at least one electrophoretic display film or at least one electrowetting display film.
